(19) United States
(12) Patent Application Publication
(10) Pub. No.: US 2022/0019004 A1
(43) Pub. Date: Jan. 20, 2022

(54) OPTICALLY FUNCTIONAL ABSORBING SOLUTION COMPOSITION, INFRARED ABSORBING GLASS USING SAME, INFRARED CUT FILTER COMPRISING SAME, VISIBLE-LIGHT ABSORBING GLASS, AND INFRARED TRASMITTING FILTER COMPRISING SAME

(71) Applicant: L SQUARE INC., Chungcheongnam-do (KR)

(72) Inventors: Tae Geun LEE, Hwaseong-si (KR); Gwang Hyeong LEE, Gunpo-si (KR)

(73) Assignee: L SQUARE INC., Chungcheongnam-do (KR)

(21) Appl. No.: 17/295,334

(22) PCT Filed: Feb. 8, 2019
(86) PCT No.: PCT/KR2019/001590

§ 371 Date: May 19, 2021

(30) Foreign Application Priority Data
Nov. 20, 2018 (KR) 10-2018-0143363

(51) Int. Cl. G02B 5/20; G02B 5/00; G02B 1/11; G02B 5/22; C03C 17/30; C03C 17/34; C09D 5/32; C09D 7/20; C09D 7/41; C09D 183/06; C08G 77/20; C08K 5/00

(52) U.S. Cl. CPC G02B 5/208; C03C 2218/151; G02B 1/11; G02B 5/226; C03C 17/30; C03C 17/3417; C09D 5/32; C09D 7/20; C09D 7/41; C09D 183/06; C08G 77/20; C08K 5/0041; C03C 2217/734; C03C 2218/11; G02B 5/003

(57) ABSTRACT

The present invention relates to an optically functional absorbing solution composition, infrared absorbing-enhanced glass using same, and an infrared transmitting filter comprising same, the optically functional absorbing solution composition comprising: a resin having a siloxane group substituted at an acrylic group; an organic solvent; and a dye comprising heat resistant dyes and/or non-heat-resistant dyes.

### TECHNICAL FIELD

The present invention relates to an optically functional absorbing solution composition, an infrared absorbing glass using the same, an infrared cut filter comprising the same, a visible-light absorbing glass, and an infrared transmitting filter comprising the same.

### BACKGROUND ART

Recently, the demand for digital camera modules using image sensors is significantly increasing due to the increasing spread of smartphones and tablet PCs. The development strategy of the digital camera modules used in such mobile devices is directed toward achieving a thinner thickness and higher definition.

Image signals of the digital camera modules are received through an image sensor. The image sensor including a semiconductor is designed to have a characteristic of responding to wavelengths similar to those observed by a human within a visible region. However, unlike human eyes, the image sensor has a characteristic of responding even to wavelengths within an infrared region, so that an infrared cut filter (IR cut filter) configured to block the wavelengths within the infrared region is required in order to obtain information on images similar to those observed by the human eyes.

In order to minimize such a problem, an infrared cut filter including an infrared absorbent is widely used in a high-pixel structure.

However, when an absorbing material is directly formed on a glass, it is difficult to implement adhesion between the glass and the absorbing material, which is required by the filter.

Therefore, there is an increasing demand for an infrared blocking material with ensured adhesion to a glass.

In addition, recently, there is an increasing demand for a band pass filter capable of transmitting only infrared light within a specific wavelength range for object recognition and biometric recognition in a smartphone.

In order to implement the above configuration, a demand for a visible-light absorbing material with ensured adhesion to a glass is also increasing.

### DOCUMENTS OF RELATED ART

### Patent Documents

(Patent document 1) KR 2009-0074794 A

### DETAILED DESCRIPTION OF THE INVENTION

### Technical Problem

Therefore, to solve the problems described above, an object of the present invention is to provide an optically functional absorbing solution composition capable of forming an infrared-light and visible-light blocking material with ensured adhesion to a glass.

Another object of the present invention is to provide an optical filter that may be prepared by a simple method by using an optically functional absorbing solution composition and is capable of blocking infrared light and visible light.

Still another object of the present invention is to provide a module having an optical filter including an infrared-light and visible-light blocking material.

### Technical Solution

To achieve the objects described above, according to the present invention, there is provided an optically functional absorbing solution composition including: a resin having a siloxane group substituted at an acrylic group; an organic solvent; and a dye including at least one of a heat-resistant dye and a non-heat-resistant dye.

In addition, the present invention provides an infrared absorbing glass, wherein a transparent glass may be formed thereon with an optically functional absorbing layer including: a resin having a siloxane group substituted at an acrylic group; and a dye including at least one of a heat-resistant dye and a non-heat-resistant dye.

In addition, the present invention provides an infrared cut filter including: an infrared absorbing glass; an anti-reflection layer formed on a first surface of the infrared absorbing glass; and an IR reflective layer formed on a second surface of the infrared absorbing glass.

In addition, the present invention provides a visible-light absorbing glass, wherein a transparent glass may be formed thereon with an optically functional absorbing layer including: a resin having a siloxane group substituted at an acrylic group; and a dye including at least one of a heat-resistant dye and a non-heat-resistant dye.

In addition, the present invention provides an infrared transmitting filter including: a visible-light absorbing glass; and an anti-reflection layer formed on a first surface of the visible-light absorbing glass.

The present invention provides a camera module including an infrared cut filter.

The present invention provides a biometric module including an infrared transmitting filter.

### Advantageous Effects

According to the infrared cut filter and the infrared transmitting filter of the present invention,

adhesion between the optically functional absorbing layer and the glass can be ensured, so that peeling can be prevented from occurring, a heat resistance can be improved at a high temperature, and occurrence of cracks can be reduced.

### DESCRIPTION OF THE DRAWINGS

FIG. 1 is a photograph for comparing film formation effects according to Example 1 and Comparative examples 1 and 2.

FIG. 2 is a photograph for comparing surface haze characteristics according to Example 1 and Comparative examples 3 and 4.

FIG. 3 is a photograph for comparing crack occurrence degrees according to Example 1 and Comparative examples 5 and 6.

FIG. 4 is a photograph for comparing peeling and stickiness degrees according to Example 1 and Comparative examples 7 and 8.

FIG. 5 is a graph showing light absorption characteristics before and after a heat resistance test according to Example 1 of the present invention.

FIG. 6 is a graph showing light absorption characteristics before and after a heat resistance test according to Example 2 of the present invention.

FIG. 7 is a graph showing light absorption characteristics before and after a heat resistance test according to Example 3 of the present invention.

FIG. 8 is a graph showing light absorption characteristics before and after a heat resistance test according to Comparative example 1 of the present invention.

FIG. 9 is a graph showing light absorption characteristics before and after a heat resistance test according to Comparative example 2 of the present invention.

FIG. 10 is a graph showing light absorption characteristics before and after a heat resistance test according to Comparative example 9 of the present invention.

### BEST MODE

Hereinafter, the present invention will be described in detail with reference to the accompanying drawings so that those of ordinary skill in the art may easily implement the present invention. Terms and words used in the present disclosure and the claims shall not be interpreted as being limited to commonly-used or dictionary meanings, but shall be interpreted as having meanings and concepts relevant to the technical idea of the present invention based on the principle that the inventor may appropriately define the concept of the term to describe his/her own invention in the best way.

In the drawings, parts irrelevant to the description are omitted to clearly describe the present invention, and similar reference numerals are used for similar parts throughout the present disclosure. In addition, a size and a relative size of an element shown in the drawings are not related to the actual scale, and may be reduced or exaggerated for clarity of description.

Optically Functional Absorbing Solution Composition

According to the present invention, an optically functional absorbing solution composition may include: a resin having a siloxane group substituted at an acrylic group; an organic solvent; and a mixed dye including at least one of a heat-resistant dye and a non-heat-resistant dye.

The resin having the siloxane group substituted at the acrylic group may be represented by Formula 1.

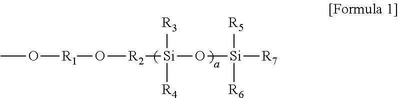

(In Formula 1, R₁ denotes CH₂, R₂ denotes an alkylene group having 1 to 3 carbon atoms, and each of R₃ to R₇ denotes an alkyl group having 1 to 3 carbon atoms.)

Since the optically functional absorbing solution composition according to the present invention uses the resin having the siloxane group substituted at the acrylic group as described above, when the optically functional absorbing solution composition is applied onto a glass substrate, Si in the resin may make contact with a glass to form a bond with the glass, so that adhesion to the glass may be improved.

According to the optically functional absorbing solution composition of the present invention, the organic solvent may include chloroform, cyclohexanone, tetrahydrofuran (THF), toluene, hexane, or a mixture of at least two thereof.

Since the optically functional absorbing solution composition according to the present invention uses the organic solvent as described above, the resin and the dye may be properly dispersed, and the adhesion to the glass may be ensured.

According to the optically functional absorbing solution composition of the present invention, a content of the resin having the siloxane group substituted at the acrylic group may be 40 parts by weight to 90 parts by weight based on 100 parts by weight of the organic solvent. When the content of the resin having the siloxane group substituted at the acrylic group is less than 40 parts by weight, there is a problem that cracks may occur during curing, and when the content of the resin having the siloxane group substituted at the acrylic group is more than 90 parts by weight, there is a problem that a transmittance may be decreased.

According to the optically functional absorbing solution composition of the present invention, the mixed dye may include at least one of the heat-resistant dye and the non-heat-resistant dye.

The heat-resistant dye may use at least one selected from the group consisting of a squarylium-based compound, a cyanine-based compound, a phthalocyanine-based compound, a naphthaocyanine-based compound, and a dithiol metal complex compound, and may have less than 0.5% of a transmittance variation of an absorption maximum caused by heat when exposed at 120° C. for 96 hours or more.

The non-heat-resistant dye may use at least one selected from the group consisting of a squarylium-based compound, a cyanine-based compound, a phthalocyanine-based compound, a naphthalocyanine-based compound, and a dithiol metal complex compound, and may have 0.5% or more of a transmittance variation of an absorption maximum caused by heat when exposed at 120° C. for 96 hours or more.

The optically functional absorbing solution composition according to the present invention may further include a curing agent. A conventional heat curing agent or a conventional photocuring agent used in the art may be used as the curing agent.

A content of the curing agent may be 4 parts by weight to 10 parts by weight based on 100 parts by weight of the resin having the siloxane group substituted at the acrylic group. When the content of the curing agent is less than 4 parts by weight, stickiness may occur after the curing, and when the content of the curing agent is more than 10 parts by weight, peeling may occur after the curing.

Infrared Absorbing Glass

According to the present invention, there may be provided an infrared absorbing glass, wherein a transparent glass is formed thereon with an optically functional absorbing layer including: a resin having a siloxane group substituted at an acrylic group; and a dye including at least one of a heat-resistant dye and a non-heat-resistant dye.

The optically functional absorbing layer may be formed by applying the optically functional absorbing solution composition according to the present invention onto the transparent glass, and curing the applied optically functional absorbing solution composition, in which a Si component of the resin having the siloxane group substituted at the acrylic group and a transparent glass component may be bonded to each other so as to improve adhesion.

Although any substrate having a glass component may be used as the transparent glass without particular limitation, at least one selected from the group consisting of a transparent tempered glass and a general optical glass may be preferably used as the transparent glass.

In addition, configurations of components in the optically functional absorbing layer may be the same as the configurations of the components of the optically functional absorbing solution composition described above.

An infrared absorbing-enhanced glass prepared as described above may have an absorption maximum in a range of 600 nm to 800 nm.

Infrared Cut Filter

According to the present invention, an infrared cut filter may include: the infrared absorbing glass; an anti-reflection layer formed on a first surface of the infrared absorbing glass; and an IR reflective layer formed on a second surface of the infrared absorbing glass.

The infrared cut filter according to the present invention may include the infrared absorbing glass.

The infrared absorbing glass may have the configuration described above.

The infrared cut filter according to the present invention may include the anti-reflection layer formed on the first surface of the infrared absorbing glass.

The anti-reflection layer may serve to prevent reflection of external light and reduce diffused reflection that affects contrast, and may be provided on the infrared absorbing glass. To this end, the anti-reflection layer may generally have a reflectance of 3.0% or less, and more preferably, a reflectance of 1.8% or less. In addition, a low-refractive-index layer may be used as the anti-reflection layer, and a refractive index of the anti-reflection layer may be lower than a refractive index of the infrared absorbing glass. In detail, the refractive index of the anti-reflection layer may preferably be in a range of 1.20 to 1.55, and more preferably, in a range of 1.30 to 1.50. The anti-reflection layer may have a thickness of 0.1 μm to 25 μm, but is not necessarily limited thereto.

Preferably, without particular limitation, a layer formed by depositing at least one selected from the group consisting of silicon oxide (SiO₂), silicon nitride (SiNₓ), titanium oxide (TiO₂), aluminum (Al), and aluminum oxide (Al₂O₃) may be used as the anti-reflection layer.

The infrared cut filter according to the present invention may include the IR reflective layer formed on the second surface of the infrared absorbing glass.

The IR reflective layer refers to a layer configured to block IR in the infrared cut filter according to the present invention, and particularly, the IR reflective layer may serve to reflect infrared light to block the infrared light.

According to the present invention, a layer having the same physical properties as the anti-reflection layer described above may be used as the IR reflective layer. Preferably, without particular limitation, a layer formed by depositing at least one selected from the group consisting of silicon oxide (SiO₂), silicon nitride (SiNₓ), titanium oxide (TiO₂), aluminum (Al), and aluminum oxide (Al₂O₃) may be used as the IR reflective layer.

The infrared cut filter according to the present invention may have a wavelength value between 600 nm and 660 nm at a point in which a transmittance is 50% at a wavelength of 500 nm or more and 1000 nm or less.

Visible-Light Absorbing Glass (Infrared Transmitting Glass)

According to the present invention, there may be provided a visible-light absorbing glass, wherein a transparent glass is formed thereon with an optically functional absorbing layer including: a resin having a siloxane group substituted at an acrylic group; and a dye including at least one of a heat-resistant dye and a non-heat-resistant dye.

The optically functional absorbing layer may be formed by applying the optically functional absorbing solution composition according to the present invention onto the transparent glass, and curing the applied optically functional absorbing solution composition, in which a Si component of the resin having the siloxane group substituted at the acrylic group and a transparent glass component may be bonded to each other so as to improve adhesion.

Although any substrate having a glass component may be used as the transparent glass without particular limitation, at least one selected from the group consisting of a transparent tempered glass and a general optical glass may be preferably used as the transparent glass.

In addition, configurations of components in the optically functional absorbing layer may be the same as the configurations of the components of the optically functional absorbing solution composition described above.

The visible-light absorbing glass prepared as described above may have a wavelength value between 700 nm and 1000 nm at a point in which a transmittance is 50% at a wavelength of 500 nm or more and 1000 nm or less.

Infrared Transmitting Filter

According to the present invention, an infrared transmitting filter may include: the visible-light absorbing glass; and an anti-reflection layer formed on a first surface of the visible-light absorbing glass.

The infrared transmitting filter according to the present invention may include the visible-light absorbing glass.

The visible-light absorbing glass may have the configuration described above.

The infrared transmitting filter according to the present invention may include the anti-reflection layer formed on the first surface of the visible-light absorbing glass.

The anti-reflection layer may serve to prevent reflection of external light and reduce diffused reflection that affects contrast, and may be provided on a transparent film. To this end, the anti-reflection layer may generally have a reflectance of 3.0% or less, and more preferably, a reflectance of 1.8% or less. In addition, a low-refractive-index layer may be used as the anti-reflection layer, and a refractive index of the anti-reflection layer may be lower than a refractive index of the transparent film. In detail, the refractive index of the anti-reflection layer may preferably be in a range of 1.20 to 1.55, and more preferably, in a range of 1.30 to 1.50. The anti-reflection layer may have a thickness of 0.1 μm to 25 μm, but is not necessarily limited thereto.

Preferably, without particular limitation, a layer formed by depositing at least one selected from the group consisting of silicon oxide (SiO₂), silicon nitride (SiNₓ), titanium oxide (TiO₂), aluminum (Al), and aluminum oxide (Al₂O₃) may be used as the anti-reflection layer.

The infrared transmitting filter according to the present invention may have a wavelength value between 700 nm and 1000 nm at a point in which a transmittance is 50% at a wavelength of 500 nm or more and 1000 nm or less.

In addition, the infrared transmitting filter according to the present invention may have a maximum transmittance of 10% or less between a wavelength of 500 nm and 650 nm.

In addition, the infrared transmitting filter according to the present invention may have 50 nm or less of a wavelength variation for 50% of a transmittance when exposed at 80° C. for 120 hours or more.

Since the infrared cut filter and the infrared transmitting filter have optical characteristics as described above, the infrared cut filter and the infrared transmitting filter may be used for optical or biometric application.

In detail, the optical application may include a camera module and the like, and the biometric application may include fingerprint recognition, iris recognition, face recognition, and the like.

Cameral Module

Recently, the demand for digital camera modules using image sensors is significantly increasing due to the increasing spread of smartphones and tablet PCs. The development strategy of the digital camera modules used in such mobile devices is directed toward achieving a thinner thickness and higher definition.

Image signals of the digital camera modules are received through an image sensor. The image sensor including a semiconductor is designed to have a characteristic of responding to wavelengths similar to those observed by a human within a visible region. However, unlike human eyes, the image sensor has a characteristic of responding even to wavelengths within an infrared region, so that an infrared cut filter (IR cut filter) configured to block the wavelengths within the infrared region is required in order to obtain information on images similar to those observed by the human eyes.

In order to minimize such a problem, an infrared cut filter including an infrared absorbent is widely used in a high-pixel structure.

Biometric Module

The biometric module according to the present invention may include the infrared transmitting filter.

The biometric module according to the present invention may be applied to any module configured to provide, through hardware, a function of capturing a face, a fingerprint, an iris, and the like of a user and converting collected information into biometric information.

In the present invention, the module refers to a unit for processing a specific function or operation, which may be implemented through hardware, software, or a combination of hardware and software.

Hereinafter, embodiments of the present invention will be described in detail. However, the embodiments according to the present invention may be modified into various other forms, and the scope of the present invention shall not be construed as being limited to embodiments that will be described below. The embodiments of the present invention are provided for a more complete understanding of the present invention to those of ordinary skill in the art.

### EXAMPLE

### Example 1

<Preparation of Encapsulating Dye Composition>

An encapsulating dye composition was prepared by mixing 1.2 g of a heat-resistant dye (AE-2 dye made by Excitonin USA) having less than 0.5% of a transmittance variation of an absorption maximum caused by heat when exposed at 120° C. for 96 hours or more with 0.2 g of a non-heat-resistant dye (AH-2 dye made by Hayasibara in Japan) having 0.5% or more of a transmittance variation of an absorption maximum caused by heat when exposed at 120° C. for 96 hours or more, adding 50 g of cyclohexanone, and performing polymerization and stirring for 5 hours.

<Preparation of Optically Functional Absorbing Solution Composition>

An optically functional absorbing solution composition was prepared by adding 20 g of a resin having a siloxane group substituted at an acrylic group and 6 wt % of a curing agent to the prepared encapsulating dye composition, and performing polymerization and stirring for 5 hours.

The resin having the siloxane group substituted at the acrylic group was prepared by hydrolyzing methyltrichlorosilane and a mixture using the same.

<Preparation of Infrared Absorbing-enhanced Glass>

An infrared absorbing-enhanced glass was prepared by preparing a 100-μm transparent tempered glass (D263T (made by Schott in Germany)), applying the optically functional absorbing solution composition onto the transparent tempered glass with a thickness of 1.5 μm, and performing drying at 130° C. for 60 minutes.

<Preparation of Infrared Cut Filter>

A 2.5-μm anti-reflection layer was formed by alternately depositing, with an E-beam evaporator, TiO₂ and SiO₂ on a surface of the infrared absorbing-enhanced glass coated with the optically functional absorbing solution composition. Thereafter, an infrared cut filter was prepared by alternately depositing TiO₂ and SiO₂ on an opposite surface of the infrared absorbing-enhanced glass with the E-beam evaporator to form a 2.9-μm IR reflective layer.

### Example 2

An encapsulating dye composition, an optically functional absorbing solution composition, an infrared absorbing-enhanced glass, and an infrared cut filter were prepared in the same manner as in Example 1 except that a heat-resistant dye (AE-3 dye made by ExcitoninUSA) having less than 0.5% of a transmittance variation of an absorption maximum caused by heat when exposed at 120° C. for 96 hours or more was used instead of the heat-resistant dye (AE-2 dye made by Exciton in USA) having less than 0.5% of the transmittance variation of the absorption maximum caused by the heat when exposed at 120° C. for 96 hours or more.

### Example 3

<Preparation of Dye Composition>

An encapsulating dye composition was prepared by mixing 1.0 g (AC1 dye made by H company in Korea), 1.0 g (AC2 dye made by H company in Korea), 0.8 g (AC5 dye made by H company in Korea), 0.1 g (AE-3 dye made by Exciton in USA) of heat-resistant dyes having less than 0.5% of a transmittance variation of an absorption maximum caused by heat when exposed at 120° C. for 96 hours or more with 10 g of chloroform, and performing polymerization and stirring for 5 hours.

<Preparation of Optically Functional Absorbing Solution Composition>

An optically functional absorbing solution composition was prepared by adding 20 g of a resin having a siloxane group substituted at an acrylic group (product name RN1, made by N company) to the prepared encapsulating dye composition, and performing polymerization and stirring for 5 hours.

<Preparation of Visible-Light Absorbing-enhanced Glass>

Preparation was performed in the same manner as in Example 1.

<Preparation of Infrared Transmitting Filter>

An infrared transmitting filter was prepared by alternately depositing, with the E-beam evaporator, TiO₂ and SiO₂ on a surface of the visible-light absorbing-enhanced glass coated with the optically functional absorbing solution composition to form a 2.5-μm anti-reflection layer.

### Comparative Example 1

<Preparation of Encapsulating Dye Composition>

An encapsulating dye composition was prepared by mixing 1.2 g of a heat-resistant dye (AE-2 dye made by Exciton in USA) having less than 0.5% of a transmittance variation of an absorption maximum caused by heat when exposed at 120° C. for 96 hours or more with 0.2 g of a non-heat-resistant dye (AH-2 dye made by Hayasibara in Japan) having 0.5% or more of a transmittance variation of an absorption maximum caused by heat when exposed at 120° C. for 96 hours or more, adding 50 g of cyclohexanone, and performing polymerization and stirring for 5 hours.

<Preparation of Optically Functional Absorbing Solution Composition>

An optically functional absorbing solution composition was prepared by adding 10 g of a resin (U2 made by JCN in Japan) to the prepared encapsulating dye composition, and performing polymerization and stirring for 5 hours.

<Preparation of Infrared Absorbing-enhanced Glass>

An infrared absorbing-enhanced glass was prepared by preparing a 100-μm transparent tempered glass (D263T (made by Schott in Germany)), applying the optically functional absorbing solution composition onto the transparent tempered glass with a thickness of 1.5 μm, and performing drying at 130° C. for 60 minutes.

<Preparation of Infrared Cut Filter>

A 2.5-μm anti-reflection layer was formed by alternately depositing, with an E-beam evaporator, TiO₂ and SiO₂ on a surface of the infrared absorbing-enhanced glass coated with the optically functional absorbing solution composition. Thereafter, an infrared cut filter was prepared by alternately depositing TiO₂ and SiO₂ on an opposite surface of the infrared absorbing-enhanced glass with the E-beam evaporator to form a 2.9-μm IR reflective layer.

### Comparative Example 2

<Preparation of Encapsulating Dye Composition>

An encapsulating dye composition was prepared by mixing 1.2 g of a heat-resistant dye (AE-2 dye made by Exciton in USA) having less than 0.5% of a transmittance variation of an absorption maximum caused by heat when exposed at 120° C. for 96 hours or more with 0.2 g of a non-heat-resistant dye (AH-2 dye made by Hayasibara in Japan) having 0.5% or more of a transmittance variation of an absorption maximum caused by heat when exposed at 120° C. for 96 hours or more,

adding 50 g of cyclohexanone, and performing polymerization and stirring for 5 hours.

<Preparation of Optically Functional Absorbing Solution Composition>

An optically functional absorbing solution composition was prepared by adding 15 g of a resin (U3 made by JCN in Japan) to the prepared encapsulating dye composition, and performing polymerization and stirring for 5 hours.

<Preparation of Infrared Absorbing-enhanced Glass>

An infrared absorbing-enhanced glass was prepared by preparing a 100-μm transparent tempered glass (D263T (made by Schott in Germany)), applying the optically functional absorbing solution composition onto the transparent tempered glass with a thickness of 1.5 μm, and performing drying at 130° C. for 60 minutes.

<Preparation of Infrared Cut Filter>

A 2.5-μm anti-reflection layer was formed by alternately depositing, with an E-beam evaporator, TiO₂ and SiO₂ on a surface of the infrared absorbing-enhanced glass coated with the optically functional absorbing solution composition. Thereafter, an infrared cut filter was prepared by alternately depositing TiO₂ and SiO₂ on an opposite surface of the infrared absorbing-enhanced glass with the E-beam evaporator to form a 2.9-μm IR reflective layer.

### Comparative Example 3

An encapsulating dye composition, an optically functional absorbing solution composition, an infrared absorbing-enhanced glass, and an infrared cut filter were prepared in the same manner as in Example 1 except that methyl ethyl ketone is used instead of cyclohexanone.

### Comparative Example 4

An encapsulating dye composition, an optically functional absorbing solution composition, an infrared absorbing-enhanced glass, and an infrared cut filter were prepared in the same manner as in Example 1 except that acetone is used instead of cyclohexanone.

### Comparative Example 5

An encapsulating dye composition, an optically functional absorbing solution composition, an infrared absorbing-enhanced glass, and an infrared cut filter were prepared in the same manner as in Example 1 except that 10 g of the resin having the siloxane group substituted at the acrylic group is added.

### Comparative Example 6

An encapsulating dye composition, an optically functional absorbing solution composition, an infrared absorbing-enhanced glass, and an infrared cut filter were prepared in the same manner as in Example 1 except that 15 g of the resin having the siloxane group substituted at the acrylic group is added.

### Comparative Example 7

An encapsulating dye composition, an optically functional absorbing solution composition, an infrared absorbing-enhanced glass, and an infrared cut filter were prepared in the same manner as in Example 1 except that 20 wt % of the curing agent is added based on the resin having the siloxane group substituted at the acrylic group.

### Comparative Example 8

An encapsulating dye composition, an optically functional absorbing solution composition, an infrared absorbing-enhanced glass, and an infrared cut filter were prepared in the same manner as in Example 1 except that 2 wt % of the curing agent is added based on the resin having the siloxane group substituted at the acrylic group.

### Comparative Example 9

<Preparation of Dye Composition>

An encapsulating dye composition was prepared by mixing 1.0 g (AC1 dye made by H company in Korea), 1.0 g (AC2 dye made by H company in Korea), 0.8 g (AC5 dye made by H company in Korea), 0.1 g (AE-3 dye made by Exciton in USA) of heat-resistant dyes having less than 0.5% of a transmittance variation of an absorption maximum caused by heat when exposed at 120° C. for 96 hours or more with 10 g of chloroform, and performing polymerization and stirring for 5 hours.

<Preparation of Optically Functional Absorbing Solution Composition>

An optically functional absorbing solution composition was prepared by adding 10 g of a resin (U2 made by JCN in Japan) to the prepared encapsulating dye composition, and performing polymerization and stirring for 5 hours.

<Preparation of Visible-Light Absorbing-enhanced Glass>

Preparation was performed in the same manner as in Example 3.

<Preparation of Infrared Transmitting Filter>

An infrared transmitting filter was prepared by alternately depositing, with the E-beam evaporator, TiO₂ and SiO₂ on a surface of the visible-light absorbing-enhanced glass coated with the optically functional absorbing solution composition to form a 2.5-μm anti-reflection layer.

### Experimental Example 1: Observation of Film Formation State of Resin

1) Evaluation of Peeling

Film formation states of the infrared absorbing-enhanced glasses prepared in Example 1 and Comparative examples 1 and 2 were observed.

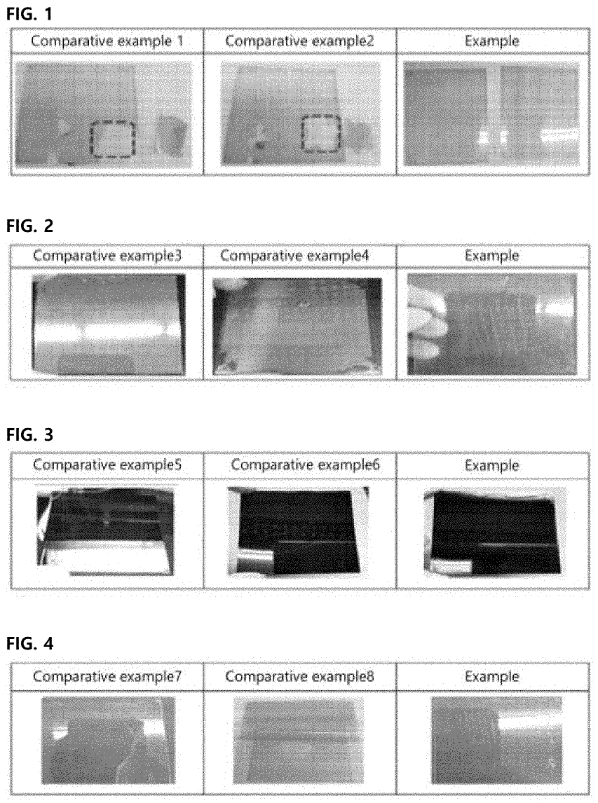

As shown in FIG. 1, in cases of Comparative examples 1 and 2 prepared by using a general resin, it was found that peeling occurs when forming a film on a glass, performing a boiling test for 1 hour at 100° C., leaving for 5 hours at a room temperature, performing scratching, and performing a peeling test by using a 3M tape 610. On the contrary, in a case of Example 1, the peeling did not occur.

From such results, it was found that it is difficult to ensure adhesion to the glass with an existing commercially available primer or resin, and that the adhesion may be ensured only when the resin according to the present invention is used.

2) Evaluation of Haze

Film formation states of the infrared absorbing-enhanced glasses prepared in Example 1 and Comparative examples 3 and 4 were observed.

As shown in FIG. 2, in cases of Comparative examples 3 and 4 prepared by using methyl ethyl ketone and acetone, it was found that a surface turns cloudy when performing application onto the transparent tempered glass with a thickness of 1.5 μm, and performing drying at 130° C. for 60 minutes. On the contrary, in the case of Example 1, a phenomenon in which a surface turns cloudy (surface haze) did not occur.

From such results, it was found that a combination of the resin according to the present invention and the solvent used for dispersion of the dye is important in order to prevent occurrence of the haze.

### Experimental Example 2: Observation of Process Improvement

1) Evaluation of Crack Improvement

Occurrence of cracks in the infrared absorbing-enhanced glasses prepared in Example 1 and Comparative examples 5 and 6 were observed.

As shown in FIG. 3, it was found that cracks did not occur after curing in the case of Example 1 in which a content ratio of the solvent and the resin is 10:5, while cracks occurred in cases of Comparative examples 5 and 6 in which the content of the resin is 10:4 or less.

From such results, it was found that a predetermined content or more of the resin has to be included in order to prevent the occurrence of cracks.

2) Evaluation of Peeling and Stickiness Improvement

Peeling and stickiness of the infrared absorbing-enhanced glasses prepared in Example 1 and Comparative examples 7 and 8 were observed.

As shown in FIG. 4, it was found that the peeling occurred in a case of Comparative example 7 in which a content ratio of the curing agent is 20 wt % based on the resin, and stickiness occurred in a case of Comparative example 8 in which the content ratio of the curing agent is 2 wt % based on the resin.

From such results, it was found that a predetermined content of the curing agent has to be included in order to prevent the peeling and the stickiness.

### Experimental Example 3: Observation of Light Absorption Characteristics

1) Infrared Absorbing Glass for Camera

First, light absorption characteristics of the infrared absorbing glasses for cameras prepared in Examples 1 and 2 and Comparative examples 1 and 2 were observed through transmittances.

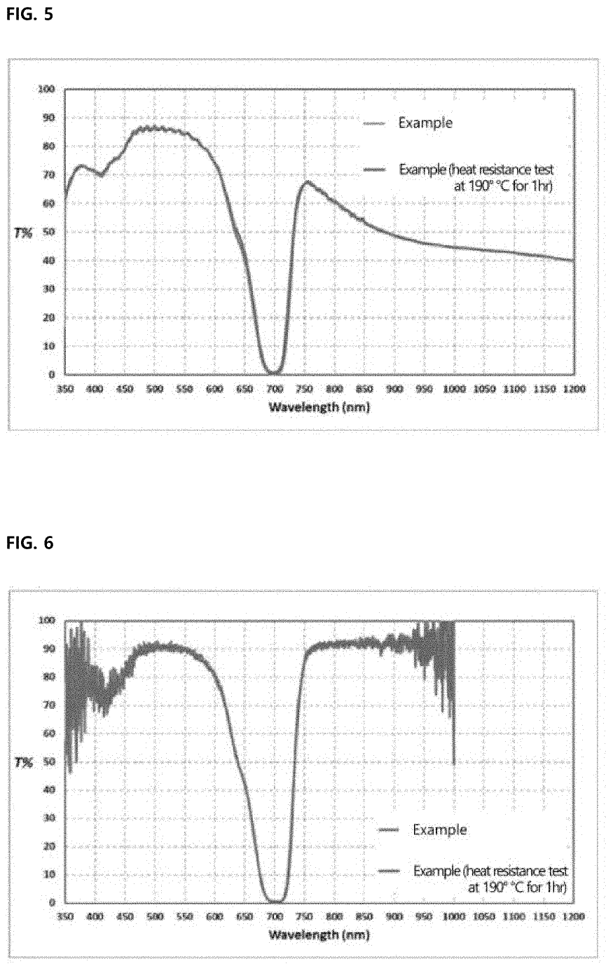

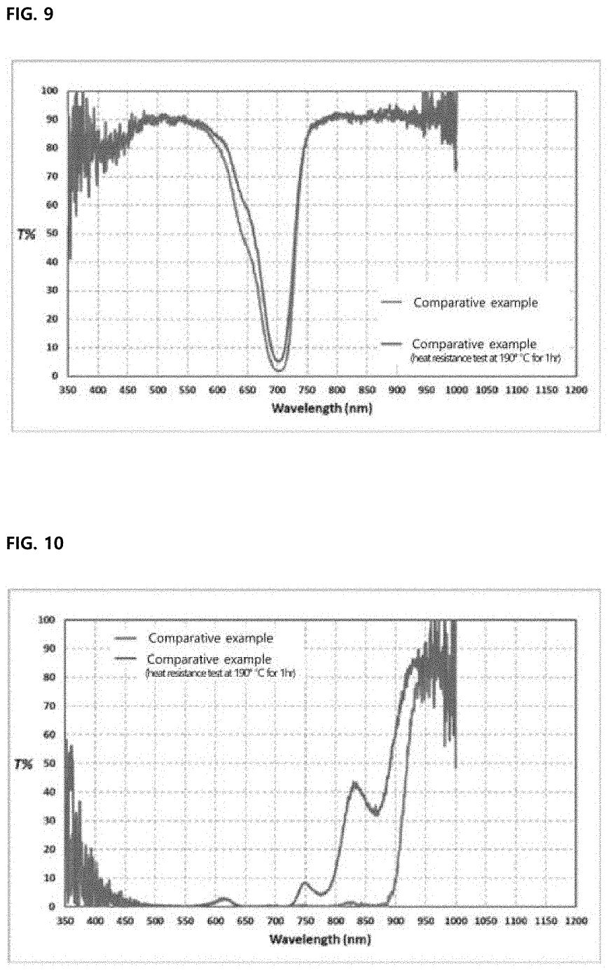

As shown in FIG. 5 (Example 1), FIG. 6 (Example 2), FIG. 8 (Comparative example 1), and FIG. 9 (Comparative example 2), unlike the infrared absorbing glasses for cameras prepared in Comparative examples 1 and 2, it was found that the light absorption characteristics are not changed after 1 hour at a high temperature of 190° C. in Examples 1 and 2. Accordingly, it was found that the infrared absorbing-enhanced glass maybe used in infrared cut filter products for cameras.

2) Visible-Light Absorbing Glass for Biometric Recognition

First, light absorption characteristics of the visible-light absorbing glasses for cameras prepared in Example 3 and Comparative example 9 were observed through transmittances.

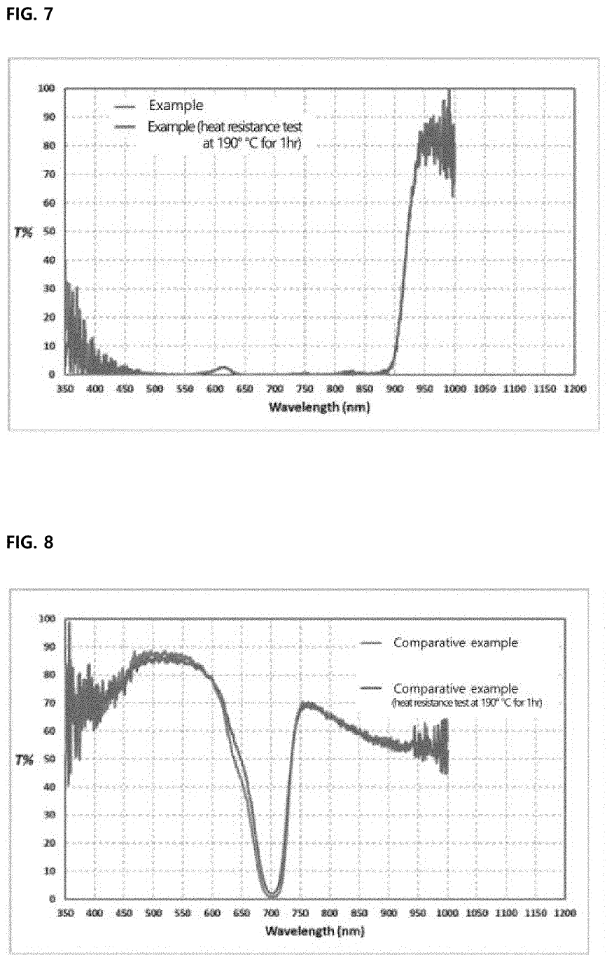

As shown in FIGS. 7 and 10, unlike the visible-light absorbing glass for the camera prepared in Comparative example 9, it was found that the light absorption characteristic is not changed after 1 hour at a high temperature of 190° C. in Example 3. Accordingly, it was found that the visible-light absorbing-enhanced glass may be used in an infrared transmitting filter product for biometric recognition.

All simple modifications or changes of the present invention belong to the scope of the present invention, and the specific scope of the present invention will be clarified by the appended claims.

1. An optically functional absorbing solution composition comprising:
a resin having a siloxane group substituted at an acrylic group;
an organic solvent; and
a dye including at least one of a heat-resistant dye and a non-heat-resistant dye.

2. The optically functional absorbing solution composition of claim 1, wherein the resin having the siloxane group substituted at the acrylic group is represented by Formula 1. 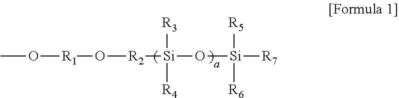
(In Formula 1, R₁ denotes CH₂, R₂ denotes an alkylene group having 1 to 3 carbon atoms, and each of R₃ to R₇ denotes an alkyl group having 1 to 3 carbon atoms.)

3. The optically functional absorbing solution composition of claim 1, wherein the organic solvent includes chloroform, cyclohexanone, tetrahydrofuran (THF), toluene, hexane, or a mixture of at least two thereof.

4. The optically functional absorbing solution composition of claim 1, wherein the heat-resistant dye includes at least one selected from the group consisting of a squarylium-based compound, a cyanine-based compound, a phthalocyanine-based compound, a naphthalocyanine-based compound, and a dithiol metal complex compound, and has less than 0.5% of a transmittance variation of an absorption maximum caused by heat when exposed at 120° C. for 96 hours or more, and
the non-heat-resistant dye includes at least one selected from the group consisting of a squarylium-based compound, a cyanine-based compound, a phthalocyanine-based compound, a naphthalocyanine-based compound, and a dithiol metal complex compound, and has 0.5% or more of a transmittance variation of an absorption maximum caused by heat when exposed at 120° C. for 96 hours or more.

5. The optically functional absorbing solution composition of claim 1, further comprising a curing agent.

6. The optically functional absorbing solution composition of claim 1, wherein a content of the resin having the siloxane group substituted at the acrylic group is 40 parts by weight to 90 parts by weight based on 100 parts by weight of the organic solvent.

7. The optically functional absorbing solution composition of claim 5, wherein a content of the curing agent is 4 parts by weight to 10 parts by weight based on 100 parts by weight of the resin having the siloxane group substituted at the acrylic group.

8. An infrared absorbing glass, wherein a transparent glass is formed thereon with an optically functional absorbing layer including: a resin having a siloxane group substituted at an acrylic group; and a dye including at least one of a heat-resistant dye and a non-heat-resistant dye.

9. The infrared absorbing glass of claim 8, wherein the transparent glass includes a transparent tempered glass.

10. The infrared absorbing glass of claim 8, wherein the optically functional absorbing layer is formed by applying an optically functional absorbing solution composition of claim 1 onto the transparent glass, and curing the applied optically functional absorbing solution composition.

11. The infrared absorbing glass of claim 8, wherein the glass is used for optical application.

12. The infrared absorbing glass of claim 8, wherein the glass has an absorption maximum in a range of 600 nm to 800 nm.

13. An infrared cut filter comprising:
an infrared absorbing glass of claim 8;
an anti-reflection layer formed on a first surface of the infrared absorbing glass; and
an IR reflective layer formed on a second surface of the infrared absorbing glass.

14. The infrared cut filter of claim 13, wherein the infrared cut filter has a wavelength value between 600 nm and 660 nm at a point in which a transmittance is 50% at a wavelength of 500 nm or more and 1000 nm or less.

15. The infrared cut filter of claim 13, wherein the infrared cut filter has 50 nm or less of a wavelength variation for 50% of a transmittance when exposed at 80° C. for 120 hours or more.

16. A visible-light absorbing glass, wherein a transparent glass is formed thereon with an optically functional absorbing layer including: a resin having a siloxane group substituted at an acrylic group; and a dye including at least one of a heat-resistant dye and a non-heat-resistant dye.

17. The visible-light absorbing glass of claim 16, wherein the transparent glass includes a transparent tempered glass.

18. The visible-light absorbing glass of claim 16, wherein the optically functional absorbing layer is formed by applying an optically functional absorbing solution composition of claim 1 onto the transparent glass, and curing the applied optically functional absorbing solution composition.

19. The visible-light absorbing glass of claim 16, wherein the glass is used for biometric application.

20. The visible-light absorbing glass of claim 16, wherein the glass has a wavelength value between 700 nm and 1000 nm at a point in which a transmittance is 50% at a wavelength of 500 nm or more and 1000 nm or less.

21. An infrared transmitting filter comprising:
a visible-light absorbing glass of claim 16; and
an anti-reflection layer formed on a first surface of the visible-light absorbing glass.

22. The infrared transmitting filter of claim 21, wherein the infrared transmitting filter has a maximum transmittance of 10% or less between a wavelength of 500 nm and 650 nm.

23. The infrared transmitting filter of claim 21, wherein the infrared transmitting filter has 50 nm or less of a wavelength variation for 50% of a transmittance when exposed at 80° C. for 120 hours or more.

24. A camera module including an infrared cut filter of claim 21.

25. A biometric module including an infrared transmitting filter of claim 13.
